(19) United States
(12) Patent Application Publication
(10) Pub. No.: US 2003/0090701 A1
(43) Pub. Date: May 15, 2003

(54) Wireless print hub systems and methods

(76) Inventors: Ron Crane, Star, ID (US); Grant Keely, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/992,208

(22) Filed: Nov. 14, 2001

(51) Int. Cl. B41J 1/00; G06F 15/00

(52) U.S. Cl. 358/1.15

(57) ABSTRACT

Systems and methods of a print hub for wireless transmission of information corresponding to print tasks is disclosed. A representative print hub system has a master printer that has a master printing mechanism capable of printing information corresponding to the print task. The master printer also has a master wireless network module adapted to wirelessly transmit information corresponding to the print task. In addition, the master printer can be configured to determine an intended destination of the print task. Further, the master printer can configure the information corresponding to the print task for wireless transmission. Another representative of the print hub includes one or more servant printers. Each servant printer has a printing mechanism that is adapted to print the information corresponding to the print task. In addition, the servant printer includes a servant wireless network module adapted to communicatively couple with the master wireless network module and receive the information corresponding to a wirelessly transmitted print task.

### TECHNICAL FIELD

The present invention is generally related to printers and, more particularly, is related to systems and methods for wirelessly transmitting print tasks from one printer to another.

### BACKGROUND OF THE INVENTION

Generally, computer network systems, such as the one shown in FIG. 1, communicatively couple via wireline connections. System 10 includes one or more computers 12A and 12B, a server 18, a network printer 14, and one or more local printers 16A and 16B. Computer 12A is communicatively coupled to the server 18, network printer 14, and the local printer 16A via respective wireline connections. In addition, computer 12B is communicatively coupled to the network printer 14 and the desktop printer 16B via respective wireline connections.

FIGS. 2A and 2B illustrate data flows typically exhibited when a print task is printed using system 10. In FIG. 2A, a user can print a print task by sending the print task to the local printer 16A indirectly through the server 18 via a wireline connection. The user can also print a print task by sending the print task to the network printer 14. In FIG. 2B, a user can print a print task by sending the print tasks to a network printer 14. In addition, the user can print a print task by sending the print task directly to the local printer 16B via a wireline connection.

In order for the user to route a print task to local printer 16A, cabling (e.g. wireline connection) is needed to connect server 18 to local printer 16A. In this regard, local printer 16A requires appropriate communication ports or interfaces so that cable can connect server 18 to local printer 16A. For example, printer 16A may include a serial, parallel, or USB port. Similarly, in order for the user to route a print task to local printer 16B, cabling is needed to connect computer 12B to the local printer 16B. In this regard, computer 12B and desktop printer 16B require appropriate communication ports or interfaces (e.g., a serial, parallel port, or USB port) so that cable can connect computer 12B to local printer 16B. Therefore, system 10 requires a potentially significant amount of cabling and appropriate interfaces to connect server 18 to local printer 16A and computer 12B to the local printer 16B. This can increase the cost of such systems. To complicate matters further, users tend to switch offices, which requires that the local printers 16A and 16B, cable, etc., be moved from place to place. This also can increase costs.

In many businesses it may be cost prohibitive to have multiple local printers 16A and 16B and, therefore, many users may share the network printer 14. This can lower productivity because it takes time for the users to walk to and from the network printer 14. Additionally, once at the network printer, the users may often have to wait for print tasks of other users to be printed before their print task is printed.

Thus, a heretofore unaddressed need exists in the industry to address the aforementioned and/or other deficiencies and/or inadequacies.

### SUMMARY OF THE INVENTION

Briefly described, the present invention provides print hub systems for wireless transmission of information corresponding to print tasks. A representative print hub system has a master printer that has a master printing mechanism capable of printing information corresponding to the print task. The master printer also has a master wireless network module adapted to wirelessly transmit information corresponding to the print task. In addition, the master printer can be configured to determine an intended destination of the print task. Further, the master printer can configure the information corresponding to the print task for wireless transmission.

Another embodiment of the print hub system includes one or more servant printers. Each servant printer has a printing mechanism that is adapted to print the information corresponding to the print task. In addition, the servant printer includes a servant wireless network module adapted to communicatively couple with the master wireless network module and receive the information corresponding to a wirelessly transmitted print task.

The present invention also involves methods for wireless transmission of information corresponding to printing tasks. The method includes: receiving information corresponding to the print task that is to be printed, the information received at a first device capable of printing the information corresponding to the print task, determining an intended destination of the information corresponding to the print task, configuring the information corresponding to the print task to be wirelessly transmitted, and transmitting wirelessly the information corresponding to the print task.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram of a prior art wireline computer network system.

FIG. 2A is a block diagram illustrating how a print task flows from the computers indirectly to the printer, as shown in FIG. 1.

FIG. 2B is a block diagram illustrating the flow of a print task from the computers directly to the printers, as shown in FIG. 1.

FIG. 3 is a schematic design of one embodiment representative of a wireless satellite print hub system of the present invention.

FIG. 4A is a flow diagram illustrating a representative flow of a print task through the wireless satellite print hub system illustrated in FIG. 3.

FIG. 4B is a flow diagram illustrating a representative flow of a print task through the wireless satellite print hub system illustrated in FIG. 3.

FIG. 5 is a flow chart illustrating a representative embodiment of the wireless satellite print hub system illustrated in FIG. 3.

FIG. 6 is a schematic diagram of one embodiment representative of the master printer illustrated in FIG. 3.

FIG. 7 is a flow diagram illustrating representative functionality of an embodiment of the master printer system illustrated in FIG. 5.

FIG. 8 is a schematic diagram of one embodiment representative of the servant printer illustrated in FIG. 3.

FIG. 9 is a flow diagram illustrating representative functionality of the servant printer system of FIG. 8.

FIG. 10 is a flow diagram illustrating representative functionality of the satellite print hub system illustrated in FIG. 3 that includes a master printer and a servant printer.

### DETAILED DESCRIPTION

The wireless print hub systems and methods of the present invention include a master printer and one or more servant printers. Generally, data flows exhibited using the wireless print hub systems of the present invention flow from the master printer to the appropriate servant printer via a wireless communication link. The wireless print hub systems of the present invention can eliminate the need for using printer cables to communicatively couple computers and servant printers of the present invention. In this regard, servant printers do not need a wireline computer/printer interface or port. Therefore, servant printers included in the wireless print hub system of the present invention can be relatively less expensive and require less set-up time (e.g., cable hook-up and software installation) than prior computer-printer systems. Furthermore, without cables to hinder movement of the servant printers, the servant printers can be easily moved from one location to another, which can add convenience and decreases related expenses.

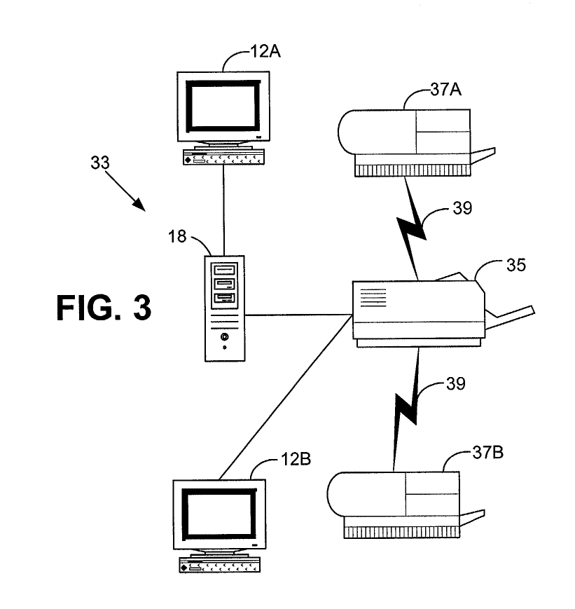

Referring again to the drawings, FIG. 3 illustrates an embodiment of the wireless satellite print hub system 33 of the present invention (hereinafter “hub system”). The hub system 33 includes a master printer 35, at least one servant printer 37A and 37B, one or more computers 12A and 12B, and a server 18. Master printer 35, computers 12A and 12B, and the server 18 are communicatively coupled. Master printer 35 and servant printers 37A and 37B are devices capable of performing one or more functions, such as for example, printing, coping, scanning, faxing, etc.

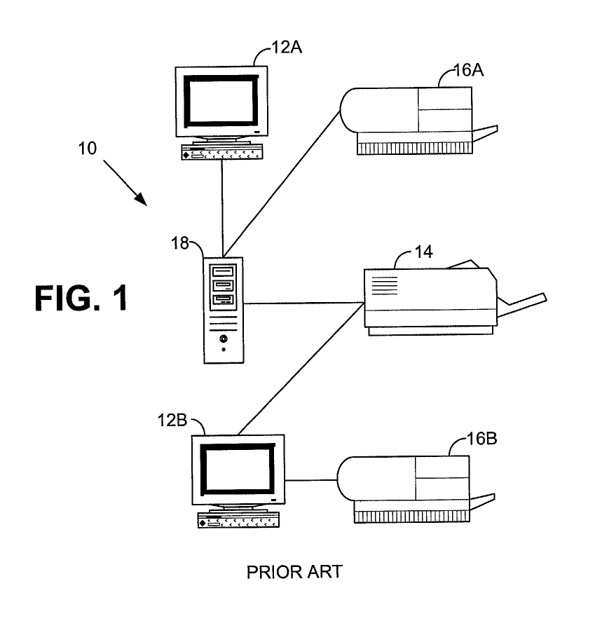

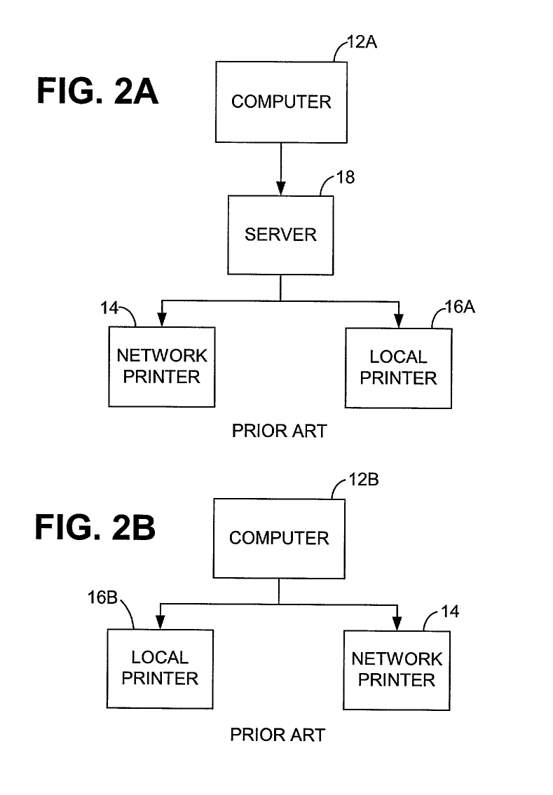

In contrast to the wireline computer network system 10 illustrated in FIG. 1, computers 12A and 12B in the hub system 33, as illustrated in FIG. 3, are not directly connected to servant printers 37A and 37B with wireline cables. Therefore, wireline cables and the concomitant communication ports are not necessary. However, computers 12A and 12B (hereinafter computer 12) are communicatively coupled to servant printers 37A and 37B (hereinafter servant printer 37) via the master printer 35. To accomplish this, the master printer 35 and the servant printer 37 are communicatively coupled via a wireless communication link 39. In this regard, the master printer 35 and the servant printer 37 include a master wireless network module and a servant wireless network module, respectively. The wireless network module of the master printer 35 and the servant wireless network module of the servant printer 37 are adapted to communicatively couple through a wireless communication link 39.

Therefore, a user can request that print tasks be printed using the servant printer 37 by sending the print tasks to the mater printer 35. The data flow of the print task can flow from the computer 12 of the user to the master printer 35 that will wirelessly transmit the information corresponding to the print task to servant printer 37.

Generally, the wireless network modules include, for example, an IEEE standard 802.11 wireless local area network card that uses the 802.11 wireless standard or a Bluetooth enabled network device that operates using the Bluetooth specification. For example, the master wireless network module and the servant network module include an 802.11 wireless card. In this regard, the 802.11 wireless card of the master wireless network module is capable of communicatively coupling with the 802.11 wireless card of the servant wireless network module. Clearly, other communication protocols and corresponding network cards/devices can be used.

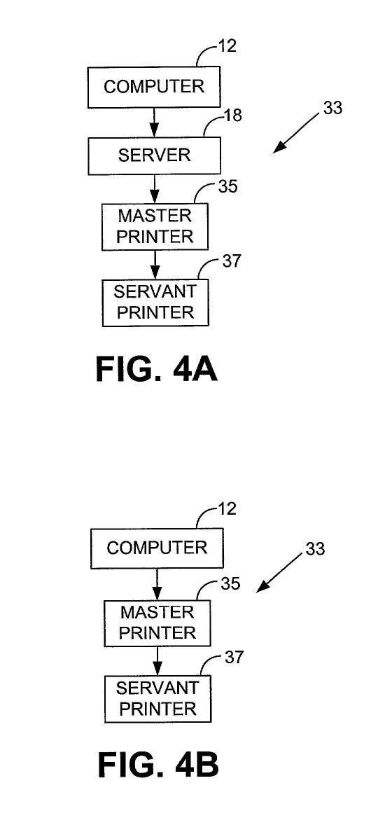

FIG. 4A is a block diagram that illustrates the flow of a print task through an embodiment of the hub system 33. The user operates computer 12 to send a print request to the master printer 35 via server 18. Thereafter, the master printer 35 wirelessly transmits the print task to the appropriate servant printer 37 via the wireless communication link 39. In contrast to the flow of FIG. 4A, FIG. 4B is a block diagram that illustrates the flow of a print task through another embodiment of the hub system 33. In this embodiment the user operates computer 12 to send a print task directly to the master printer 35. Thereafter, the master printer 35 wirelessly transmits the print task to the appropriate servant printer 37 via a wireless communication link 39.

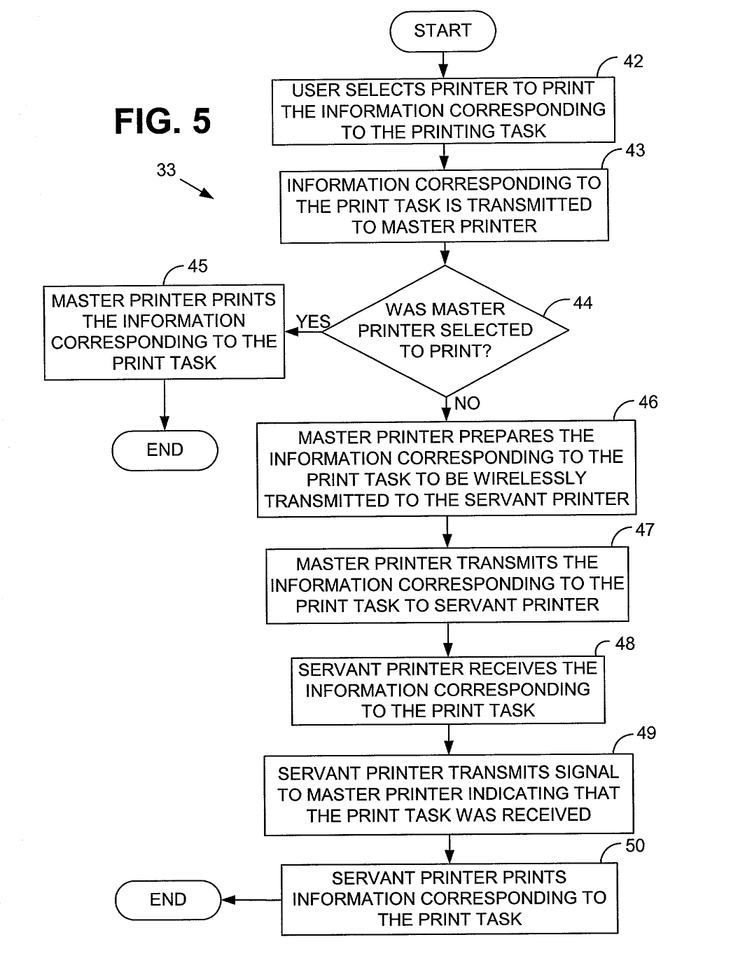

FIG. 5 is a flow diagram that illustrates an example of how a print task flows through a representative hub system 33. In block 42, the user selects the printer to which the print task is to be printed. The print task is transmitted to the master printer 35, as shown in block 43. In decision block 44, a determination is made to determine if the master printer 35 was selected to print the print task. If the determination is “yes,” then the master printer 35 prints the print task, as shown in block 45. If the determination is “no,” then the master printer 35 is adapted to prepare the print task to be wirelessly transmitted to an appropriate printer, such as the servant printer 37, as shown in block 46. After preparation of the print task for wireless transmission, the master printer 35 is adapted to wirelessly transmit the print task to the servant printer 37, as shown in block 47. Upon receiving the print task, the servant printer 37 may wirelessly transmit a confirmation signal to the master printer 35 indicating that the transmission was successfully performed, as shown in blocks 48 and 49. Transmission of a confirmation signal is not necessary. Then, servant printer 37 prints the print task using a printing mechanism, as shown in block 50.

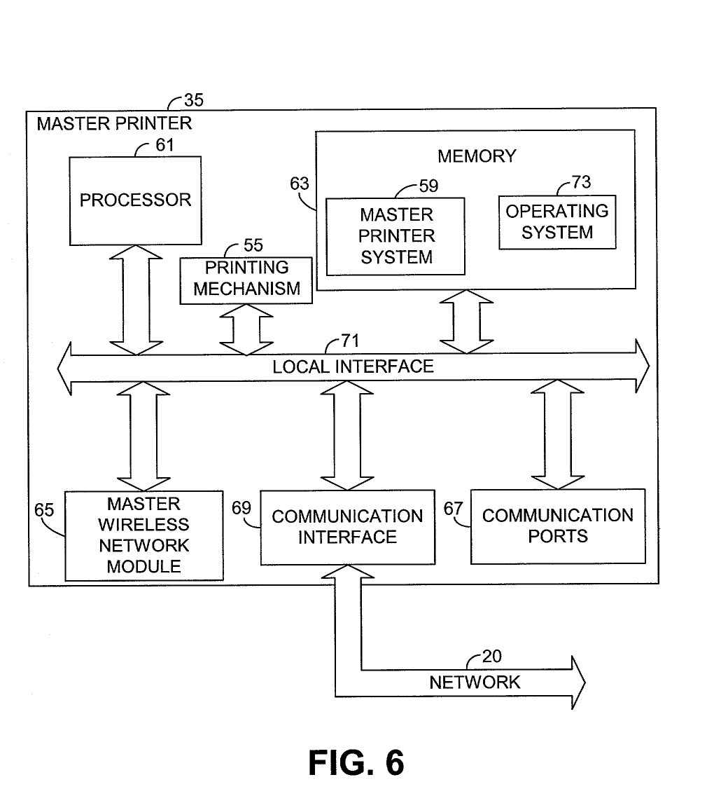

Master printer 35 includes a printing mechanism 55 as well as other components that enable the performance of printing functions, as illustrated in FIG. 6.

Master printer 35 includes a master printer system 59. The master printer system 59 can be implemented in software (e.g., firmware), hardware, or a combination thereof. In the currently contemplated best mode, the master printer system 59 is implemented in software, as an executable program. The master printer 35 can include a special or general purpose digital computer or a processor-based system that can implement the master printer system 59.

Generally, in terms of hardware architecture, as shown in FIG. 6, the master printer 35 includes a processor 61, memory 63, master wireless network module 65, communication ports 67, communication interface 69, and one or more input and/or output (I/O) devices (not shown) that are communicatively coupled via a local interface 71. The local interface 71 can be, for example, one or more buses or other wired or wireless connections, as is known in the art. The local interface 71 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The master wireless network module 65 includes, for example, an IEEE standard 802.11 wireless local area network card that operates using the IEEE 802.11 wireless standard. The 802.11 wireless local area network card is capable of operating using three different types of radio technologies: direct sequence spread spectrum (DSSS), frequency hopped spread spectrum (FHSS), and infrared. The DSSS radio technology is preferred. The IEEE 802.11 wireless standard allows data to be transmitted using encapsulation and translation modes, both are well known in the art.

In another embodiment, the master wireless network module 65 includes, for example, a Bluetooth enabled device. The communications industry has adopted the Bluetooth specification as a recommended communications technique for short distance wireless RF communication applications and is well known in the art.

The communication ports 67 include, for example, a serial port, a parallel port, a network connection, an IEEE connections, a USB bidirectional serial interface connection, and any other appropriate port or interface connection, which are well known in the art.

The master printer 35 may be interfaced to other devices, such as a computer or server, via a network 20. The network 20 can be one or more networks capable of enabling the above components to communicate and may include, for example, local area network (LAN), wireless local area network (WLAN), a metropolitan area network (MAN), a wide area network (WAN), any public or private packet-switched or other data network, including the Internet, circuit-switched networks, such as the public switched telephone network (PSTN), wireless networks, or any other desired communications infrastructure.

The processor 61 is a hardware device for executing software, particularly that stored in memory 63. The processor 61 can be any custom made or commercially available processor, a central processing unit (CPU), an auxiliary processor among several processors associated with the master printer 35, a semiconductor based microprocessor (in the form of a microchip or chip set), a macroprocessor, or generally any device for executing software instructions.

The memory 63 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 63 may incorporate electronic, magnetic, optical, and/or other types of storage media. Note that the memory 63 can have a distributed architecture, where various components are situated remote from one another, but can be accessed by the processor 61.

The software in memory 63 may include one or more separate programs, each of which comprises an ordered listing of executable instructions for implementing logical functions. In the example of FIG. 6, the software in the memory 63 includes the master printer system 59 and a suitable operating system 73 (O/S). The operating system 73 essentially controls the execution of other computer programs, such as the master printer system 59, and provides scheduling, input-output control, file and data management, memory management, and communication control and related services. In addition, the software (not shown) in memory 63 includes programs to operate the master printer 35, for example, a spooler program. A spooler program allocates memory 63 to temporarily store inputted streams of data (e.g., print tasks that are being received from one or more computers). In other words, the spooler program manages the receipt of print tasks from a computer and/or server and manages the print output of the print tasks for the master printer 35.

The master printer system 59 can be a source program, executable program (object code), script, or any other entity comprising a set of instructions to be performed. When a source program, then the program may need to be translated via a compiler, assembler, interpreter, or the like, which may or may not be included within the memory 63, so as to operate properly in connection with the O/S 73. Furthermore, the master printer system 59 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices may include input devices typically associated with printers, for example, but not limited to, a keyboard, display, etc. Finally, the I/O devices may further include devices that communicate both inputs and outputs, for instance, but not limited to, a modulator/demodulator (modem: for accessing another device, system, or network), a radio frequency (RF) or other transceiver, a telephonic interface, a bridge, a router, etc.

The master printer 35 may further include a basic input output system (BIOS) (omitted for simplicity). The BIOS is a set of essential software routines that initialize and test hardware at startup, start the O/S 73, and support the transfer of data among the hardware devices. The BIOS is stored in ROM so that the BIOS can be executed when the master printer 35 is activated.

When the master printer 35 is in operation, the processor 61 is configured to execute software stored within the memory 63, to communicate data to and from the memory 63, and to generally control operations of the master printer 35 pursuant to the software. The master printer system 59 and the O/S 73, in whole or in part, but typically the latter, are read by the processor 61, perhaps buffered within the processor 61, and then executed.

When the master printer system 59 is implemented in software, as is shown in FIG. 6, it should be noted that the master printer system 59 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The master printer system 10 can be embodied in any computer-readable medium for use by, or in connection with, an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by, or in connection with, the instruction execution system, apparatus, or device. The computer readable medium can be, for example, but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

In an alternative embodiment, where the master printer system 59 is implemented in hardware, the master printer system 59 can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Generally, the master printer 35 is capable of performing functions, such as receiving, processing, and printing print tasks. For example, these functions may include receiving print data (such as a display list, vector graphics, or raster print data), converting the print data into a stream of binary print data, supplying the stream of binary print data to the printing mechanism 55. The printing mechanism 55 enables the print task to be printed onto recording media. Printing mechanisms 55 are well known in the art and will not be discussed herein.

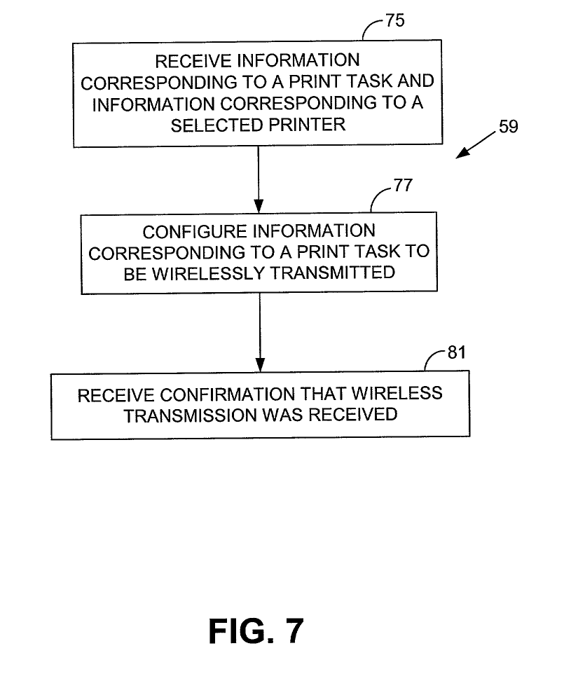

Reference will now be made to the flow diagram of FIG. 7, which illustrates a representative embodiment of a master printer system 59. As shown in block 75, the master printer system 59 can be configured to receive information corresponding to print tasks and information corresponding to the printer that has been selected to print the print task. The information corresponding to the print task is configured (e.g., formatted) to be wirelessly transmitted, as shown in block 77. In an embodiment of the master printer system 59, a confirmation or other such indication may be subsequently received to indicate that the information corresponding to the wirelessly transmitted print task was received at the selected printer destination, as shown in block 81.

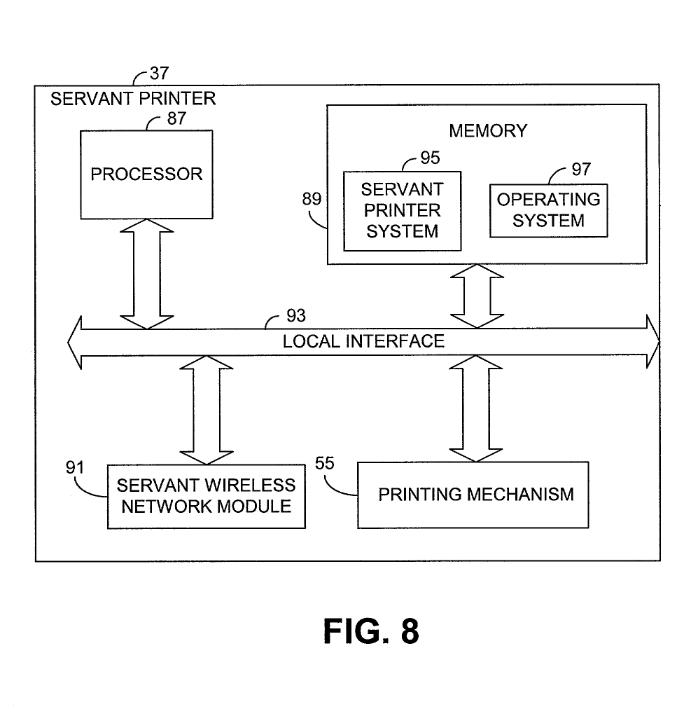

FIG. 8 is a schematic that illustrates the servant printer 37, which includes a printing mechanism 55 as well as other components that enable the servant printer 37 to perform printing operations. Any printing mechanism 55 capable of printing can be used with the servant printer 37. In addition, the servant printer 37 includes at least processing circuitry 87, memory 89, and a local interface 93. Functionality of these components are the same or similar to the corresponding components discussed in reference to the master printer 35 and will not be discussed further.

Preferably, the servant printer 37 is a host-based printer that includes a reduced amount of processing power, memory, etc., compared to a non-host based printer. Host-based printers, or “dummy” printers, are well known in the art.

The servant printer 37 also includes a servant wireless network module 91 and a servant printer system 95. The servant wireless network module 91 includes, for example, an IEEE standard 802.11 wireless local area network card. The 802.11 wireless local area network card is capable of operating using three different types of radio technologies: direct sequence spread spectrum (DSSS), frequency hopped spread spectrum (FHSS), and infrared. The DSSS radio technology is preferred. The IEEE 802.11 wireless standard allows data to be transmitted using encapsulation and translation modes, both are well known in the art. Clearly, other protocols can be used.

The wireless master network module 65 and the wireless servant network module 91 use the same radio frequency, e.g., both use DSSS. In another embodiment, the servant wireless network module 91 includes a Bluetooth enabled device. Further, the master printer 35 and the servant printer 37 are located at a distance such that the wireless communication can occur.

The software in memory 89 may include one or more separate programs, each of which comprises an ordered listing of executable instructions for implementing logical functions. In the example of FIG. 8, the software in the memory 89 includes the servant printer system 95. To implement the servant printer system 95, the master printer 35 includes an operating system 97.

The servant printer system 95 can be a source program, executable program (object code), script, or any other entity comprising a set of instructions to be performed. When a source program, then the program may need to be translated via a compiler, assembler, interpreter, or the like, which may or may not be included within the memory 89, so as to operate properly in connection with the O/S 97. Furthermore, the master printer system 95 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

When the servant printer 37 is in operation, the processor 87 is configured to execute software stored within the memory 89, to communicate data to and from the memory 89, and to generally control operations of the computer 85 pursuant to the software. The servant printer system 95 and the O/S 97, in whole or in part, but typically the latter, are read by the processor 87, perhaps buffered within the processor 87, and then executed.

When the servant printer system 95 is implemented in software, as is shown in FIG. 8, it should be noted that the servant printer system 95 can be stored on any computer readable medium for use by or in connection with any computer related system or method.

In an alternative embodiment, the servant printer system 95 can be implemented in hardware.

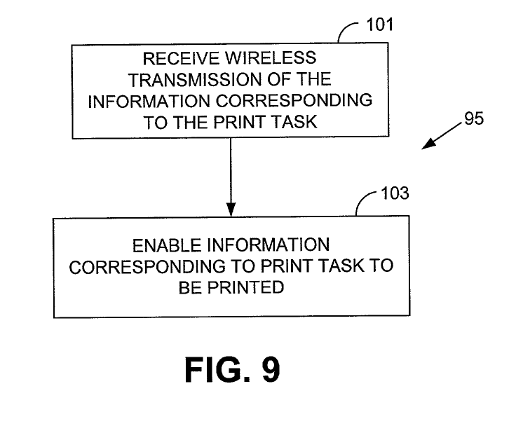

Reference will now be made to the flow diagram of FIG. 9, which illustrates functionality of a representative embodiment of a servant printer system 95. The servant printer system 95 is an exemplary system for performing the functions described in FIG. 9 and, as such, is configured to receive information corresponding to the wirelessly transmitted print tasks, as shown in block 101. Then, the servant printer system 95 is capable of enabling information corresponding to the print task to be printed, as shown in block 103. In some embodiments, after successfully receiving the information corresponding to the wirelessly transmitted print task, a confirmation or other such indication is transmitted to indicate that the information corresponding to the wirelessly transmitted print task was successfully received (not shown).

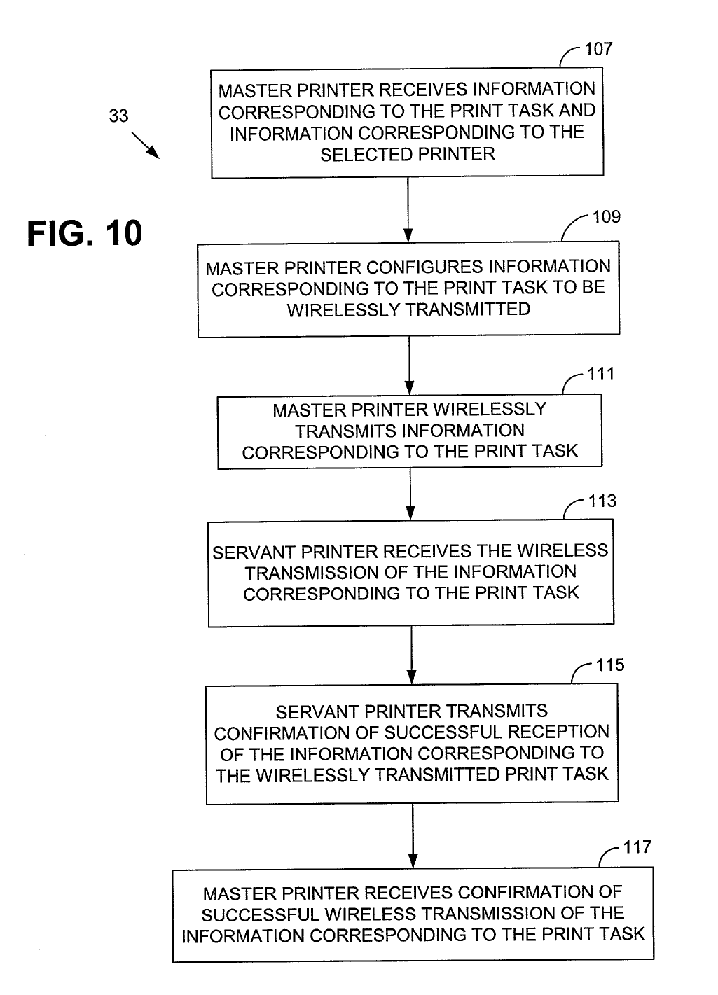

Reference will now be made to an exemplary representation of functionality of the print hub system 33 illustrated in FIG. 10. The print hub system 33, as shown in FIG. 3, is an exemplary system for performing the functions described in FIG. 10 and includes a master printer 35 and at least one servant printer 37. As shown in block 107, the master printer 35 is configured to receive information corresponding to a print task and information corresponding to a servant printer to which to print the print task. The master printer 35 is configured to wirelessly transmit the information corresponding to the print task to the selected servant printer 37, as shown in block 109. The master printer 35 is configured to wirelessly transmit the information corresponding to the print task as shown in block 111. Subsequent to the wireless transmission, the servant printer 37 is configured to receive the information corresponding to the wirelessly transmitted print task, as shown in block 113. Upon successful reception of the information corresponding to the wirelessly transmitted print task, embodiments of the servant printer 37 can be configured to transmit a confirmation signal to the master printer 35, as shown in block 115. The master printer 35 can be configured to receive the confirmation signal indicating that the information corresponding to the wirelessly transmitted print task was received, as shown in block 117.

Based on the foregoing, it should be appreciated that embodiments of the hub system 33 can overcome at least some of the deficiencies discussed above because the hub system 33 uses a wireless communication link 39 between the servant printer 37 and the master printer 35. This allows the users to have the flexibility to move from place to place without unconnecting/connecting the servant printer 37, which saves time and expense. The master printer 35 can be configured to perform all or most of the computational intensive operations (e.g., spooling), which enables the servant printer 37 to be configured with a less expensive computer system (e.g., less powerful processor and less memory). The servant printer 37 may be produced in a more cost efficient manner because it may not require wireline network or computer connections generally required by currently used printers. These cost savings allow greater access of employees to servant printers 37, with the concomitant result of higher productivity.

Many variations and modifications may be made to the above-described embodiment(s) of the hub system 33 without departing substantially from the spirit and principles of the invention. All such modifications and variations are intended to be included herein within the scope of this disclosure and the present invention and protected by the following claims.

Therefore, having thus described the invention, at least the following is claimed:

1. A print hub system for wireless transmission of information corresponding to print tasks, comprising:
a master printer including a master printing mechanism capable of printing information corresponding to the print task and a master wireless network module adapted to wirelessly transmit information corresponding to the print task, the master printer being configured to determine an intended destination of the print task and to configure the information corresponding to the print task for wireless transmission.

2. The print hub system of claim 1, further comprising:
at least one servant printer, each at least one servant printer including a printing mechanism and a servant wireless network module, the printing mechanism being adapted to print the information corresponding to the print task, the servant wireless network module being adapted to communicatively couple with the master wireless network module and receive the information corresponding to a wirelessly transmitted print task, and wherein the master printer is adapted to wirelessly transmit the information corresponding to the print task to each servant printer

3. The print hub system of claim 1, wherein the master wireless network module includes a Bluetooth device that operates using a Bluetooth specification.

4. The print hub system of claim 1, wherein the master wireless network module includes an IEEE standard 802.11 wireless local area network card that operates using a IEEE 802.11 wireless standard.

5. The print hub system of claim 2, wherein the servant wireless network module includes a Bluetooth device that operates using the Bluetooth specification.

6. The print hub system of claim 2, wherein the servant wireless network module includes a IEEE standard 802.11 wireless local area network card that operates using a IEEE 802.11 wireless standard.

7. The print hub system of claim 1, wherein the master printer includes means for transmitting the information corresponding to the print task.

8. The print hub system of claim 2, wherein the servant printer includes means for receiving the information corresponding to the print task.

9. The print hub system of claim 2, wherein the servant printer can only receive information corresponding to the print task via wireless transmission.

10. A print hub system for wireless transmission of print tasks, comprising:
at least one servant printer, each at least one servant printer including a printing mechanism and a servant wireless network module, the printing mechanism being adapted to print the information corresponding to the print task, the servant wireless network module being adapted to receive the information corresponding to a wirelessly transmitted print task.

11. The print hub system of claim 10, further comprising:
a master printer including a master printing mechanism capable of printing information corresponding to the print task and a master wireless network module adapted to wirelessly transmit information corresponding to the print task, the master printer being configured to determine an intended destination of the print task and configure the information corresponding to the print task for wireless transmission, the master printer is adapted to communicatively couple with each of the servant network wireless network modules, each servant printer is adapted to communicatively couple with the master printer, and each servant printer is adapted to receive the information corresponding to the wirelessly transmitted print task.

12. The print hub system of claim 10, wherein the servant printer can only receive information corresponding to the print task via wireless transmission.

13. The print hub system of claim 10, wherein the servant printer includes means for printing the print tasks.

14. The print hub system of claim 11, wherein the master printer includes means for configuring the information corresponding to the print task to be wirelessly transmitted.

15. A method for wireless transmission of information corresponding to printing tasks, the method comprising:
receiving information corresponding to the print task that is to be printed, the information received at a first device capable of printing the information corresponding to the print task;
determining an intended destination of the information corresponding to the print task;
configuring the information corresponding to the print task to be wirelessly transmitted; and
transmitting wirelessly the information corresponding to the print task.

16. The method of claim 15, further comprising:
receiving the wireless transmission of the information corresponding to the print task.

17. The method of claim 15, further comprising:
printing the information corresponding to the print task.

18. The method of claim 15, wherein transmitting wirelessly includes a Bluetooth device that operates using the Bluetooth specification.

19. The method of claim 15, wherein transmitting wirelessly includes a IEEE standard 802.11 wireless local area network card that operates using the IEEE 802.11 wireless standard.
